(19) United States
(12) Patent Application Publication
(10) Pub. No.: US 2014/0188449 A1
(43) Pub. Date: Jul. 3, 2014

(54) City Lifecycle Management

(71) Applicants: Reinhold Achatz, München (DE); Stefan Boschert, Neubiberg (DE); Albert Gilg, Kaufering (DE); Thomas Gruenewald, Somerset, NJ (US); George Lo, Plainsboro, NJ (US); Birgit Obst, München (DE); Roland Rosen, Herrsching (DE); Tim Schenk, Landshut (DE)

(72) Inventors: Reinhold Achatz, München (DE); Stefan Boschert, Neubiberg (DE); Albert Gilg, Kaufering (DE); Thomas Gruenewald, Somerset, NJ (US); George Lo, Plainsboro, NJ (US); Birgit Obst, München (DE); Roland Rosen, Herrsching (DE); Tim Schenk, Landshut (DE)

(21) Appl. No.: 14/235,583

(22) PCT Filed: May 9, 2012
(86) PCT No.: PCT/US12/37070

§ 371 Date: Jan. 28, 2014

(30) Foreign Application Priority Data
Aug. 1, 2011 (EP) EP 11176160

(51) Int. Cl. G06F 17/50

(52) U.S. Cl. CPC G06F 17/5009
USPC 703/6

(57) ABSTRACT

A city lifecycle management system for providing the means for city stakeholders to measure the performance of their decisions against defined key performance indicators with respect to a sustainable development of an urban area, said city lifecycle management system comprising:
a data and software platform enabling a collaborative creation and consistent management of city data of said urban area; a modelling and simulation framework using said data and software platform, wherein said modelling and simulation framework comprises software modules which evaluate interactions between city objects of one and/or different disciplines; and an application layer comprising application programs being adapted to derive the key performance indicators depending on the interactions evaluated by said software modules of said modelling and simulation framework,
   wherein said derived key performance indicators support said city stakeholders in making decision with respect to the sustainable development of the respective urban area.

The present patent document is a §371 nationalization of PCT Application Serial Number PCT/US2012/037070, filed May 9, 2012, designating the United States, which is hereby incorporated by reference. This patent document also claims the benefit of EP 11176160, filed Aug. 1, 2011, which is also hereby incorporated by reference.

### FIELD

The present embodiments relate to a method and a system for performing a city lifecycle management which can be used by city stakeholders.

### BACKGROUND

A city is a very complex structure including of many different sub-systems of different disciplines such as energy supply, water supply, waste removal, security, mobility, healthcare, education or manufacturing, environment and finances. Besides buildings and a complex infrastructure located in the city the urban area of the city is populated by humans having social and economic relations. Decisions made by stakeholders of a city, for example with reference to infrastructure objects, have also an impact on the environment and ecology of the respective area. Moreover, decisions made by stakeholders can have a direct or indirect impact on the humans living in the city. Decisions affecting one or several disciplines in a city can be made by different kinds of stakeholders at different levels of the city administration. For example, a mayor of a city or a planning or an engineering team can make an infrastructure decision with respect to an object of the city such as a building object affecting other disciplines of the city as well.

Currently city stakeholders use a multitude of different systems to plan, design, build, operate and to maintain different verticals or disciplines in a city. These conventional tools are disparate within and across the verticals hindering an optimization and sustainability of the city development. In conventional systems for planning a city development, the gathering of data information on a city is predominantly done manually. Furthermore, with conventional systems all relevant implications of decisions are at the very most backed only on a vertical/discipline level. Conventional systems do not take into account the complex interrelations between different disciplines in a city so that side effects and implications for other disciplines when making a decision in a specific discipline are not systematically evaluated and provided to city stakeholders making the decision.

### SUMMARY AND DESCRIPTION

The scope of the present invention is defined solely by the appended claims and is not affected to any degree by the statements within this summary.

Consequently, decisions made by city stakeholders are mostly heuristic and based on experience without any systematic evaluation of cross-discipline effects caused by the respective decision. Furthermore, conventional systems do not support city stakeholders by evaluating their decisions over different time horizons. Especially, long-time effects of decisions taken by city stakeholders are not considered by conventional tools. Accordingly, a city lifecycle management system that takes into account the complex interrelations of different disciplines within a city to support city stakeholders in making optimal decisions for a sustainable development of a city is desired.

Accordingly, the present embodiments provide a city lifecycle management system providing for city stakeholders to measure a performance of decisions against key performance indicators with respect to a sustainable development of an urban area, said city lifecycle management system comprising:
a data and software platform enabling a collaborative generation and consistent management of city data of said urban area;
a modelling and simulation framework using said data and software platform, wherein said modelling and simulation framework comprises software modules which evaluate interactions between city objects of the same and/or different disciplines; and
an application layer comprising application programs being adapted to derive the key performance indicators depending on the interactions evaluated by said software modules of said modelling and simulation framework,
   wherein said derived key performance indicators support said city stakeholders in making decisions with respect to the sustainable development of the respective urban area.

In a possible embodiment of the city lifecycle management system, the software modules of said modelling and simulation framework simulate multi-disciplinary interactions between city objects of different disciplines at different levels of detail and over different time horizons.

In a possible embodiment of the city lifecycle management system, the data and software platform comprises a data backbone through which city stakeholders of the same or different disciplines can exchange data in real-time and have instant access to design rationales and decisions.

In a possible embodiment of the city lifecycle management system, the software modules of said modelling and simulation framework have access to actual, historic and planned city data of said urban area stored in at least one data storage of said data and software platform via said data backbone.

In a possible embodiment of the city lifecycle management system, the modelling and simulation framework comprises configurable model libraries describing a static or dynamic behaviour of city objects within said urban area.

In a possible embodiment of the city lifecycle management system, the model libraries describe a static or dynamic behaviour of the city objects or relations between city objects of said urban area.

In a possible embodiment of the city lifecycle management system, the behaviour of the city objects comprises a physical behaviour, a social behaviour, an economic behaviour, a structural behaviour and a logical behaviour of the city objects.

In a possible embodiment of the city lifecycle management system, the city data comprises objects within said urban area including urban tangible and intangible city data, infrastructure, climatic and ecological data related to city objects and human objects within said urban area relevant to planning and sustainable development of a city.

In a possible embodiment of the city lifecycle management system, said urban infrastructure objects comprise objects of different disciplines.

In a possible embodiment of the city lifecycle management system, said urban infrastructure objects comprise building objects including different types of buildings, in particular residential buildings, commercial buildings and public buildings.

In a further possible embodiment of the city lifecycle management system, said urban infrastructure objects further comprise mobility objects including transport means, roads, railroads, subways, parking lots, bus stations, train stations, airports, water channels, harbours, pedestrian zones, bridges, tunnels and cycle tracks.

In a further possible embodiment of the city lifecycle management system, said urban infrastructure objects comprise energy supply objects including energy generators, energy storage means, energy consumers, energy prosumers, energy distribution entities and power supply lines.

In a further possible embodiment of the city lifecycle management system, said urban infrastructure objects further comprise drinking water supply objects including water supply tanks, reservoirs, water supply pipes, pumps, valves and water consumers.

In a further possible embodiment of the city lifecycle management system, said urban infrastructure objects comprise water sewage objects including spillway basins, sewer pipes, pumps, valves, rainwater collectors and sewage plants.

In a further possible embodiment of the city lifecycle management system, said urban infrastructure objects comprises health care objects such as hospitals.

In a further possible embodiment of the city lifecycle management system, the urban infrastructure objects further comprise education objects including schools, universities and research facilities.

In a further possible embodiment of the city lifecycle management system, the urban infrastructure objects further comprise manufacturing objects including factories, productions facilities and industries.

In a further possible embodiment of the city lifecycle management system, the urban infrastructure objects further comprise communication objects including data networks, telephone networks and mail delivery facilities.

In a further possible embodiment of the city lifecycle management system, the urban infrastructure objects further comprise security objects including police stations, monitoring cameras, sensor networks and fire stations.

In a further possible embodiment of the city lifecycle management system, the urban infrastructure objects further comprise waste objects including garbage collection, waste recovery and recycling facilities.

In a further possible embodiment of the city lifecycle management system, the urban infrastructure objects further comprise environment objects including gardens, recreation parks, lakes, woods and riversides.

In a further possible embodiment of the city lifecycle management system, the urban infrastructure objects further comprise financial objects including expenditures, revenues, transfers, plant maintenance and administration.

In a further possible embodiment of the city lifecycle management system, the modelling and simulation framework comprises algorithms and assets that are adapted to administer calculations to evaluate the interactions between the city objects of said urban area.

In a further possible embodiment of the city lifecycle management system, the city stakeholders exchange data between each other by interfaces connected to said data backbone of said data and software platform.

In a further possible embodiment of the city lifecycle management system, the application programs of said application layer comprise:
city and infrastructure planning applications,
city and infrastructure design applications,
city management applications,
simulation applications,
optimization applications,
rescue and emergency applications,
social impact evaluation applications,
environment impact evaluation applications, and
forecast applications including short term, mid term and long term forecast applications.

In a further possible embodiment of the city lifecycle management system, the key performance indicators comprise key performance indicators of cities for different disciplines including emission, budget, congestion, energy, water, waste, waste-water prosumption, quality of life, economic growth, land use, water usage, refurbishment potential, and population development, including demographic and employment development, indicators.

In a further possible embodiment of the city lifecycle management system, the city data comprises geodetic data and semantic information of said city objects within said urban area.

Other embodiments further provide a method for providing key performance indicators forming a basis for decisions taken by city stakeholders with respect to a sustainable development of an urban area comprising the acts of:
providing data comprising urban infrastructure objects and/or human objects within said urban area;
evaluating interactions between said objects; and
deriving the key performance indicators depending on the evaluated interactions.

In a possible embodiment of the method, the interactions between city objects of different disciplines are evaluated and simulated at different levels of detail and over different time horizons.

In a possible embodiment of the method, the simulation of the interactions between the objects is performed on the basis of a static or dynamic behaviour of the city objects read from module libraries describing a behaviour of city objects and relations between city objects.

### BRIEF DESCRIPTION OF THE DRAWINGS

In the following, possible embodiments of a city lifecycle management system and of a method for providing key performance indicators are described with reference to the enclosed figures in more detail.

FIG. 1 shows a block diagram for illustrating a possible embodiment of a city lifecycle management system;

FIG. 2 shows a diagram for illustrating a possible embodiment of a city lifecycle management system;

FIG. 3 shows a further diagram for illustrating a possible embodiment of a city lifecycle management system;

FIG. 4 shows a flow chart of a possible embodiment of a method for providing key performance indicators;

FIG. 5 shows a further diagram for illustrating a possible embodiment of a city lifecycle management system;

FIG. 6 shows an example of city data comprising city objects in an urban area as used by the city lifecycle management system;

FIGS. 7, 8 show a specific example of city data as used by a city lifecycle management system illustrating the application of a city lifecycle management system for planning purposes; and

FIGS. 9, 10 show a specific example for illustrating data provided to city stakeholders as the basis for making decisions output by the city lifecycle management system.

### DETAILED DESCRIPTION

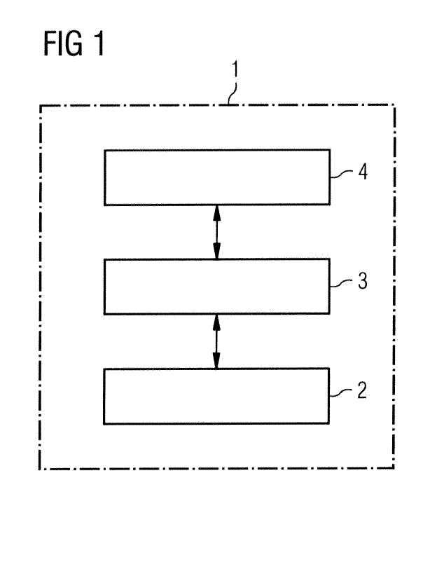

As can be seen from FIG. 1, the city lifecycle management system 1 can comprise different interacting components. The city lifecycle management system 1 provides a way for city stakeholders to measure a performance of decisions against key performance indicators (KPI) with respect to a sustainable development of an urban area. The city lifecycle management system 1 includes, in the shown embodiment of FIG. 1, a data software platform 2 enabling a collaborative generation and consistent management of city data of the urban area. This data and software platform includes a technical platform and architecture. The data and software platform can include formatters, interfaces, portals and an integrated development environment (IDE).

The data and software platform 2 can include at least one data backbone including a data network. The city stakeholders can exchange data with each other and with other users by interfaces connected to the data backbone of the data and software platform 2. In some applications, this exchange of data can be performed in real-time. The different city stakeholders communicate with each other over the data backbone of the data and software platform 2 shown in FIG. 1. This allows real-time visibility of city key performance indicators KPI for fast information driven decisions at every stage of the city lifecycle. Consequently, a seamless information flow between city stakeholders along the city lifecycle and highly efficient decision processes with a low latency can be provided. An integration between different divisions and city stakeholders is possible. The data and software platform 2 provides for consistent data in different disciplines.

The city lifecycle management system 1 as shown in FIG. 1 further includes a modelling and simulation framework 3 using the data and software platform 2. The modelling and simulation framework 3 includes software modules and evaluates interactions between city objects of the same or different disciplines. The software modules of the modelling and simulation framework 3 simulate multi-disciplinary interactions between city objects of different disciplines. The simulation can be performed at different levels of detail and over different time horizons. Software modules of the modelling and simulation framework 3 can have access to actual, historic and planned city data of the urban area. The city data can be stored in at least one data storage or database of the data and software platform 2 and can be accessible via the data backbone of the data and software platform 2. The data storage storing the city data can be, in a possible implementation, a central database. In a preferred embodiment, the data storage is a distributed data storage for storing the actual, historic and planned city data in different memories accessible via the data and software platform 2. Software modules of the modelling and simulation framework 3 can include different kinds of functional modules, such as a key performance indicator processor forecast module, an optimizer module or a simulation module.

In a possible embodiment, the modelling and simulation framework 3 further comprises configurable model libraries describing a static or dynamic behaviour of city objects within the urban area. The model libraries can describe a behaviour of city objects over time. Further, the model libraries can describe relations between city objects of the urban area. The behaviour of the city objects described in the model library includes a physical behaviour of the city objects but also a social or economic behaviour of city objects. Further, the behaviour of the city objects can include structural behaviour or a logical behaviour of city objects. The behaviour described by the configurable module libraries can be a static behaviour but also a dynamic behaviour of the respective city objects.

The modelling and simulation framework 3 includes, in a possible embodiment, algorithms and assets that are adapted to administer calculations to evaluate the interactions between the city objects of said urban area. The methods can administer generic algorithms and calculations to evaluate and process models, data and information. The models can, for example, include 3D models. The data extraction and data processing of data models is performed according to any kind of generic algorithms provided by said modelling and simulation framework 3.

The city lifecycle management system 1 as shown in the embodiment of FIG. 1 further includes an application layer 4 of application programs. These application programs are adapted to derive key performance indicators (KPI) depending on the interactions evaluated by said software modules of said modelling and simulation framework 3. The key performance indicators (KPI) derived by the application layer 4 support city stakeholders in making their decisions with respect to a sustainable development of the respective urban area.

The application layer 4 includes application programs, such as city and infrastructure planning applications. Furthermore, the application layer 4 can include city and infrastructure design applications as well as city management applications. Further, the applications of the application layer 4 can include simulation applications or optimization applications. In a further possible embodiment, the application layer 4 can further include rescue and emergency applications or social impact evaluation applications. The applications programs can further include environment impact evaluation applications or forecast applications. The forecast applications can include short term, mid term or long term forecast applications.

The application programs can be executed by program execution units of processors or terminals connected via interfaces to the data backbone of said data and software platform 2. The terminals can be fixed or mobile terminals used by city stakeholders when making decisions having an impact on the development of the urban area. The application programs can be interactive and shared by several city stakeholders. The application programs can include software tools adapted to specific city stakeholder's demands and requirements.

The city data stored in data storage in distributed form can include a plurality of city objects within the urban area. These city objects can include infrastructure objects and human objects located within the urban area and being relevant to planning and sustainable development of the respective city. There can be other kinds of city objects, such as objects affecting the climate of the city or ecological objects.

The city objects stored in the data storage of the system include urban infrastructure objects of different disciplines. The urban infrastructure objects can include a plurality of buildings of different kinds and types. The urban infrastructure objects can include building objects including different types of buildings, such as residential building objects, commercial building objects and public building objects. More kinds or types of building objects can be defined and stored as city objects in the data storage of the city life cycle management system 1.

A second kind of urban infrastructure objects can include mobility or transport objects, including transport means, roads, railroads, subways, parking lots, bus stations, train stations, airports, water channels, harbours, pedestrian zones, bridges, tunnels and cycle tracks within the respective city.

The urban infrastructure objects of the city data can further include energy supply objects. These energy supply objects can include energy generators, energy storage means, energy consumers, energy prosumers, energy distribution entities and power supply lines.

The urban infrastructure objects of the city data as stored in the distributed data storage of the city lifecycle management system 1 can further include drinking water supply objects, including water supply tanks, reservoirs, water supply pipes, pumps, valves and water consumers.

The urban infrastructure objects can further include water sewage objects, including spillway basins, sewer pipes, pumps, valves, rainwater collectors or sewage plants.

In a possible embodiment, the urban infrastructure objects stored as city data in the data storage of the city lifecycle management system 1 can further include health care objects, such as hospitals or the like.

In a further possible embodiment of the city lifecycle management system 1, the urban infrastructure objects of the city data stored in the data storage of the city lifecycle management system 1 can include education objects including schools, universities and research facilities.

Furthermore, the urban infrastructure objects of the city lifecycle management system 1 can include manufacturing objects, including factories and production facilities or whole industries.

In a further possible embodiment, the urban infrastructure objects stored as city data in a data storage of the city lifecycle management system 1 can include communication objects including network elements, data networks, public and cellular telephone networks as well as mail delivery facilities.

City objects stored as city data in a data base or data storage of the city lifecycle management system 1, can further include security objects, including police stations, monitoring cameras, sensor networks, fire stations or the like.

In a possible embodiment, the urban infrastructure objects stored as city data in a data base or data storage of the city lifecycle management system 1 can include waste objects, including garbage collection, waste recovery or recycling facilities.

In a possible implementation, the urban infrastructure objects stored as city data in a data storage of the city lifecycle management system 1 can include environment objects, including gardens, recreation parks, lakes, woods or riversides.

In a possible implementation of the city lifecycle management system 1, the city data include as city objects also financial objects, including expenditure, revenue, transfer, plant maintenance and administration objects.

The above mentioned urban infrastructure objects can be objects of different types and complexity and might be, in a possible implementation, sub-entities including objects of their own. For example, a train station as a mobility object might include different mobility objects, such as train platforms for different trains including transport devices, which can include wagons used for transporting goods or persons. Each city object can include several other city objects, wherein interrelations between city objects can be stored in a repository.

Each city object can have a determined static or dynamic behaviour. For example, a mobility object, such as transport device for transporting persons, can have a transport velocity as a physical behaviour for transporting people from one station to another station. For example, an energy generator forming an energy supply object can have a photovoltaic generation unit, which generates energy depending on the current weather (e.g., producing more energy on a sunny day than on a cloudy day). Besides, this kind of dynamic behaviour, the city objects can also include a static behaviour. For example, a road forming a mobility object can have the static behaviour that the road connects two other roads being mobility objects to each other. The city object can include a dynamic or static behaviour with respect to different disciplines. For example, a train as a transport forming a mobility object can have the behaviour of transporting a predetermined number of passengers from a first train station to a second train station and showing further the behaviour of consuming more energy when transporting the passengers from the first train station to the second train station than when standing idle at a train station. Accordingly, each city object can be a complex object including behaviour describing data describing the behaviour of the city object with respect to other city objects of different disciplines and indicating relations to other city objects.

In particular, each city object can include geodetic data indicating the position of the respective city object within the urban area. Some city objects can include static geodetic data. For example, building objects include static geodetic data or coordinates indicating the permanent location of the building object within the city. Other city objects, for example mobility objects, include dynamic geodetic data showing the current position of the city object within the urban area.

The city data can also include semantic information of the respective city objects within the urban area.

Besides, the infrastructure objects the city data can also include other city objects, in particular human objects of people living in the respective urban area. Human objects can be interrelated to urban infrastructure objects. For example, a human object can be located in a residential building object during night and work in an office building represented by another building object during the day. Further, a mobility object such as a train can be configured to transport a predetermined number of human objects from one location to the other. Further, a human object can, for example, be a consumer of drinking water provided by drinking water supply objects and produce waste water supplied to water sewage objects. Further, human objects can show a static or dynamic behaviour with respect to different disciplines. Human objects can include data describing the behaviour of single humans but also of a group of people. Human objects can interact with infrastructure objects and other human objects.

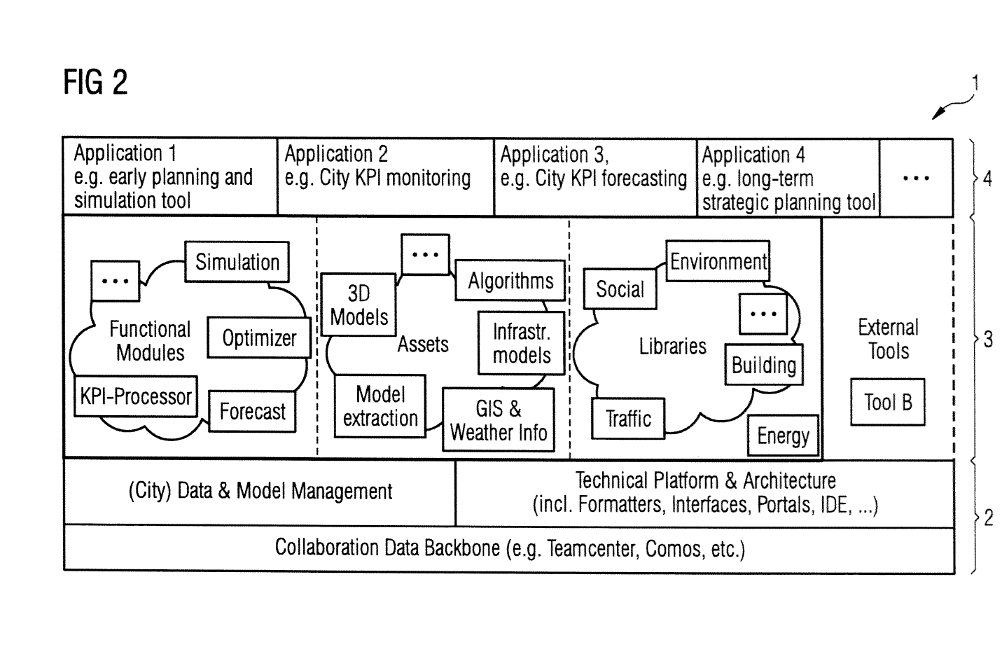

FIG. 2 shows a diagram for illustrating a possible implementation of a city lifecycle management system 1. As can be seen in FIG. 2, the city lifecycle management system 1 includes a data and software platform 2 and a modelling and simulation framework 3 as well as an application layer 4 including different application programs. The application programs of the application layer 4 use the software modules of the modelling and simulation framework 3 and evaluate interactions between city objects of the same or different disciplines. The software modules of the modelling and simulation framework 3 have access to the data and software platform 2 providing the city data comprising city objects.

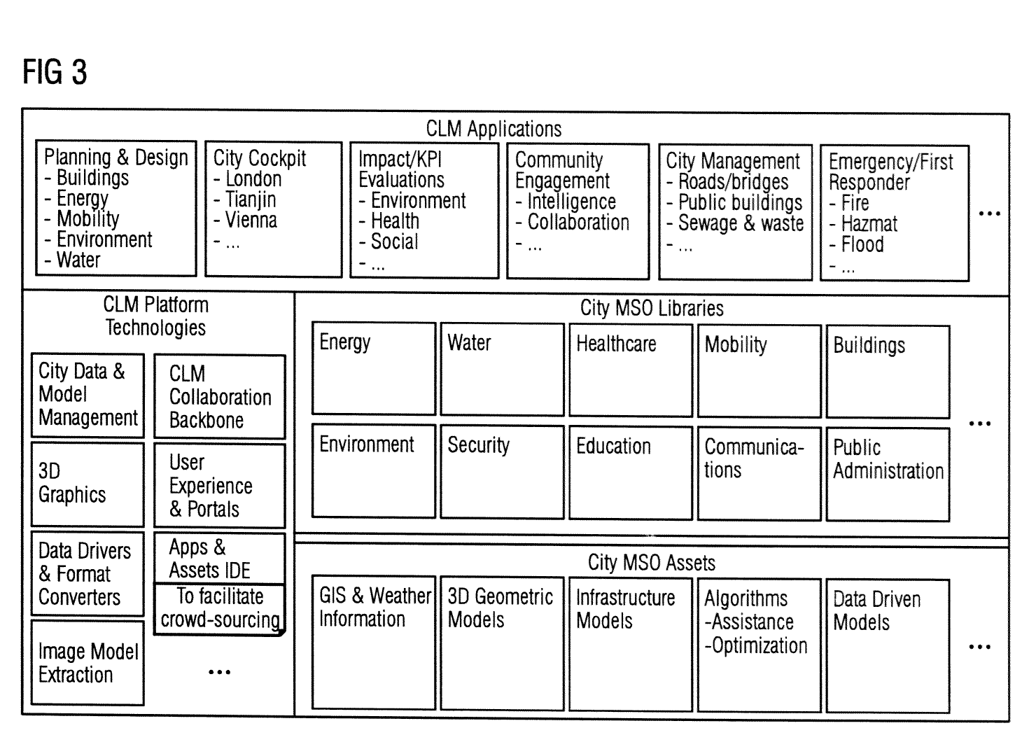

FIG. 3 shows a further diagram for illustrating a city lifecycle management system 1. The city lifecycle management applications programs of the application layer 4 use the software modules of the modelling, simulation and optimization (MSO) libraries and the modelling, simulation and optimization (MSO) assets within the modelling and simulation framework 3. The data and software platform 2 can include different platform technologies such as a city data and module management, three-dimensional graphics, data drivers and format converters, image module extractions, a collaboration backbone, user experience and portals as well as applications and assets of the integrated development environment IDE.

The city lifecycle management system 1 as shown in FIGS. 1, 2 and 3 includes an integrative IT solution and supports city stakeholders making informed decisions with respect to a sustainable development of the urban area. The collaborative data backbone enables the city stakeholders from different disciplines to exchange ideas in real-time, capture and share best practices as well as track requirements and decisions taken by city stakeholders. The modelling and simulation framework 3 provides the ability to simulate multidisciplinary interplay/interactions at different levels of details and time horizon. This allows the exploration of solution alternatives in order to support city stakeholders in making their decisions faster.

The city stakeholders can include a city major, city planners or any kind of decision makers. The city stakeholders can even include citizens of the respective urban area. The indicators provided by the application programs of the application layer 4 can include key performance indicators KPI of cities for different disciplines including key performance indicators of emissions, budget, congestion, energy, water, waste, waste-water prosumption, quality of life, economic growth, land use, water usage, refurbishment potential and population development, including demographic and employment development. This calculated key performance indicators (KPI) can be displayed by the city lifecycle management system 1 to stakeholders making decisions with respect to the development of the city. This allows a collaborative, interactive and immediate feedback of the city stakeholders.

The city lifecycle management system 1 allows to substantiate decisions in specific verticals or disciplines such as traffic, water and/or energy supply for example by the assistance of simulative evaluation and forecast application programs. Specifically, a technical analysis using a simulation can be performed in order to predict a behaviour of at least parts of a respective discipline in parallel to several other disciplines on a city level. The city lifecycle management system 1 provides a cross-discipline simulation. The city lifecycle management system 1 provides technical ways for city decision makers or stakeholders to evaluate and to predict the impacts of the decisions on the city and its relevant key performance indicators (KDI). For example, users and city stakeholders of the city lifecycle management system 1 can include city planners, traffic planners, building planners or utility planners. The forecast provided by the city lifecycle management system 1 can, for example, provide a forecast concerning a traffic situation, a security situation, an ecological balance, an economic development, a social impact, a financial status and even a quality of life for the people living in a specific area of the city. The city lifecycle management system 1 can use as a database a current city status including, for example, statistical figures or field data. Further, global factors such as ecological trends, economic trends, demographic trends, changing laws or global policies provided by a database via a network such as the internet can be used to calculate the key performance indicators (KPI). Further, the key performance indicators can also be calculated on the basis of influencable factors which can be influenced by the city stakeholders such as city budget or local policy regulations.

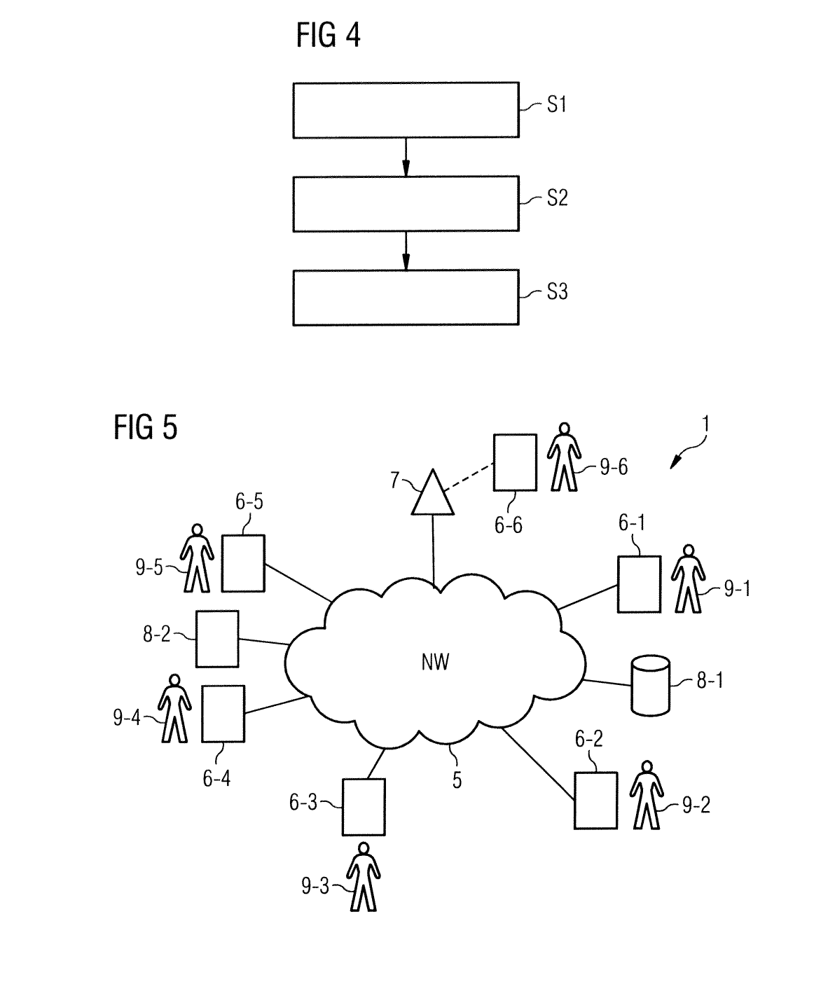

FIG. 4 shows a flow chart of a possible embodiment of a method for providing key performance indicators (KPI).

In a first act S1, city data including urban infrastructure objects and/or human objects within the urban area are provided. In a second act S2, the interactions between the objects are evaluated. Finally, in act S3 the key performance indicators (KPI) are derived depending on the evaluated interactions.

The evaluation of the interaction between the objects of different disciplines in act S2 can be performed at different levels of detail and over different time horizons. In a possible embodiment, the city stakeholders can select different levels of detail for calculation of the key performance indicators (KPI). Moreover, the city stakeholders can set different time horizons for the calculation of the key performance indicators (KPI), in particular to evaluate also long-term developments. The evaluation of the interactions between the objects can be performed on the basis of a static or dynamic behaviour of the city objects read from model libraries, which can describe the behaviour of city objects and relations between the city objects. A plurality of different kinds of city objects and of different disciplines can be available in a database. It is possible that city stakeholders can generate by a creation tool a city object and define a corresponding behaviour of the city object. For example, a city planner as a city stakeholder can generate as a city object as an urban infrastructure object, for example, a road consisting of lanes each having a traffic transport capacity for a predetermined number of cars per hour. Accordingly, a city stakeholder can create and configure a city object.

A plurality of city objects of the same discipline can be provided by the data base of the respective discipline. For example, a water supply network of the city can include a plurality of drinking water supply objects including water supply tanks, reservoirs, water supply pipes etc. For each water supply object specific data such as height, area, capacity or the like can be stored in a repository along with behaviour data of the respective water supply object.

FIG. 5 shows a further diagram for illustrating a possible embodiment of a city lifecycle management system 1. As can be seen in FIG. 5, the city lifecycle management system 1 includes in the shown implementation a data network 5 as part of the data backbone of the data and software platform 2 to allow a collaborative generation and consistent management of city data of the respective city. To the network 5, a plurality of user interfaces 6 are connected directly or indirectly, for example via an access point 7 as shown in FIG. 5. Further, one or several databases 8 can be accessible through the network 5. FIG. 5 shows also different stakeholders 9-1-9-6 using the city lifecycle management system 1 to make decisions for a sustainable development of the urban area. The city stakeholders 9 can be, for example, city planners, planning to build a road through the city, wherein the city planners want to know which impact that infrastructure decision has on other disciplines of the city. The city stakeholders can also be citizens of the city participating in the decision-making process of a decision having an impact on their daily life.

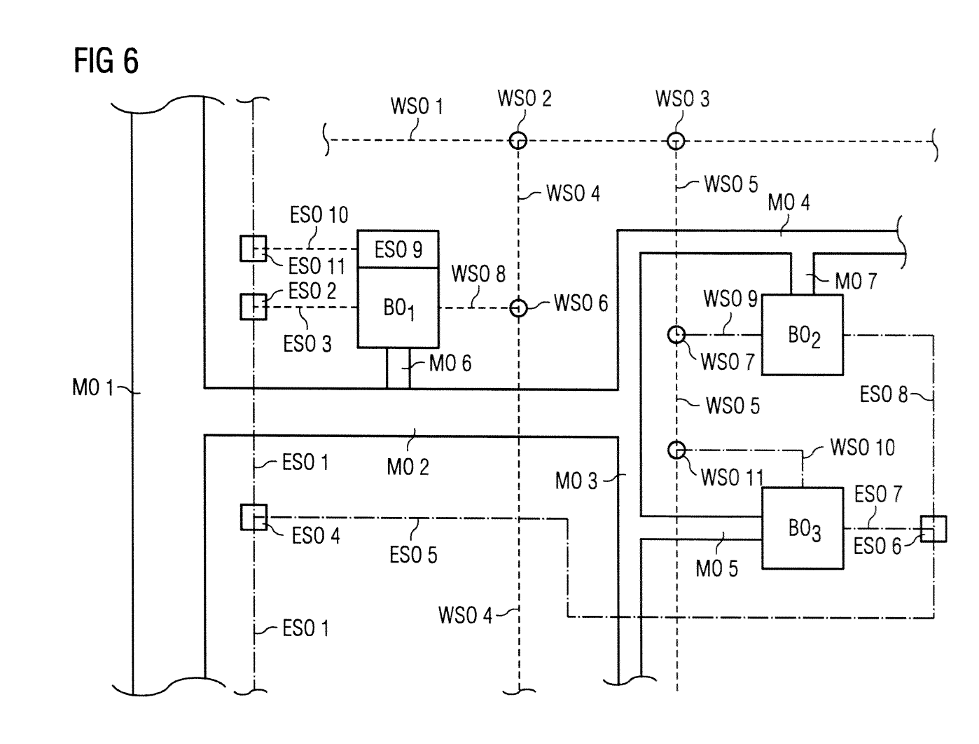

FIG. 6 shows a specific example for a city data stored in a data storage of a city lifecycle management system 1 including city objects of different disciplines. In the shown simple example of FIG. 6, a part of the city is shown including urban infrastructure objects of different disciplines. In the shown example of FIG. 6, there are building objects BO, mobility objects MO as well as water supply objects WSO. FIG. 6 shows energy supply objects ESO supplying objects with energy. For example, a mobility object MO3 is connected via a mobility object MO2 to a big road MO1. The mobility object MO3 and mobility objects MO4, MO5 are streets for reaching building objects BO2, BO3. The building object BO3 is connected via a lane forming a mobility object MO5 to the street MO3. A further building object BO2 is connected to the street MO4 via a lane MO7. A second building object BO2 has access to the mobility object MO2 via the mobility object MO6.

The building objects BO1, BO2, BO3 are connected to an energy supply grid and a water supply infrastructure. A main power supply line forms an energy supply object ESO1 which supplies energy to the first building object BO1 via a power supply distribution entity forming an energy supply object ESO2 and a power supply line ESO3. Further, there is a power supply distribution unit ESO4 for supplying energy via the energy supply line ESO5 to a further energy distribution unit forming an energy supply object ESO6. The third building BO3 is connected to the power supply distribution object ESO6 via a power supply line ESO7. The second building object BO2 is connected to the energy supply object ESO6 via the power supply line ESO8.

Furthermore, the building objects BO1, BO2, BO3 can receive drinking water from water supply objects WSO. A main water supply line WSO 1 is linked by water supply distribution entities WSO2, WSO3 to water supply lines WSO4, WSO5. At a water distribution entity WSO6 the first building object BO1 is connected to the water supply object WSO4 by a water supply line WSO8. The second building object BO2 is connected to the water supply object WSO5 via a water supply line WSO 9 at the water supply distribution entity WSO7. The third building object BO3 is connected to the water supply object WSO5 by a water supply line WSO10 at a water supply distribution entity WSO11.

Accordingly, the city data includes a plurality of city objects, in particular urban infrastructure objects of different disciplines. In the shown example of FIG. 6, the infrastructure objects include building objects BO, mobility objects MO, energy supply objects ESO as well as water supply objects WSO. Different city objects of the different disciplines are interrelated to each other (i.e., each city object has one or several relations to other city objects). For example, the energy supply line ESO 3 connects the energy supply object ESO2 with the building object BO1. Each city object shows a static or dynamic behaviour. For example, the energy supply object ESO3 forming a power supply line can include a predetermined physical behaviour. For example, a physical behaviour of the energy power supply line ESO3 can be described as the power, which can be transported to the building object BO1 via the power supply line within a predetermined time. The physical behaviour of a city object can be expressed by a function, an equation, a differential equation, a differential equation system, a matrix or by one or several attributes. The behaviour of a city object can be static or dynamic. For example, the transport capacity of a mobility object MO or an energy supply object ESO can change over time. For example, a photovoltaic facility provided on a roof of the building object BO can form an energy supply object ESO9 connected via a line ESO10 to an energy feeding point ESO11 connecting the photovoltaic facility to the energy supply grid. The energy generated by the energy supply object ESO9 can vary over time. For example, the photovoltaic object ESO9 can produce more energy during day light than at night. Furthermore, the physical behaviour of the energy supply unit ESO9 depends from other factors such as the weather. On a sunny day the energy supply object ESO9 formed by a photovoltaic unit will generate more energy than on a cloudy day. City objects can be linked to each other by relations or links and can be also connected semantically. A possible relation is for example that the building object BO1 is supplied with energy by an energy supply object ESO3. Further relations are, for example, that the roof of a building object 1 forms an energy supply object ESO9 or that a photovoltaic unit ESO9 does generate energy depending on weather data supplied by a sensor unit or a network entity such as a weather forecast server.

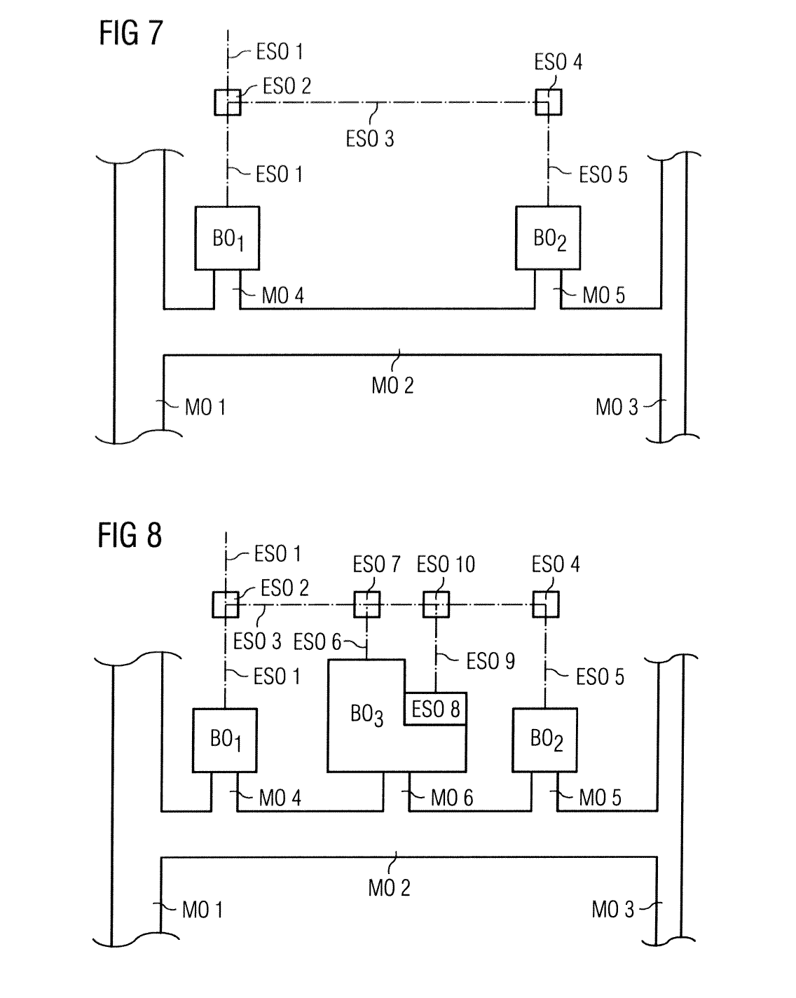

FIGS. 7, 8 show a further example for illustrating the functionality of a city lifecycle management system 1. FIG. 7 shows a data structure of part of the city including city objects of different disciplines. In the example of FIG. 7, the city objects include building objects BO1, BO2 and mobility objects MO1-MO5 as well as energy supply objects ESO1-ESO5. The first building object BO1 is connected to a road MO2 via a lane MO4 and the second building object BO2 is connected to the same road MO2 via a lane MO5. The building objects BO1, BO2 are connected via energy supply lines ESO1, ESO5, ESO3 by means of energy distribution units ESO2, ESO4. FIG. 7 shows, for example, a given situation within an urban area where the construction of a further building, for example, the building object BO3 is planned. The building object BO3 is, for example, a big commercial building, which is planned to be built between the building object BO1 and the building object BO2. FIG. 8 shows the planned infrastructure wherein the building object BO3 is planned to be accessible by the road MO2 and a connecting lane MO6. The energy supply of the building object BO3 is provided by connecting the building object 3 to the existing energy supply object ESO3 by means of an energy supply line ESO6 and an energy distribution unit ESO7. The building object BO3 is planned to have a photovoltaic facility ESO8 connected to the energy supply line ESO3 via an energy supply line ESO 9 at an energy feeding point ESO10. In a possible situation, a decision stakeholder wants to know what impacts a decision to build the building BO3 as shown in FIG. 8 will have on the situation and development of the respective city. Constructing the building described as a data model by the building object BO3 will have an impact of the traffic situation in the respective part of the city, for example, the traffic density on the road MO2. The building represented by the building object BO3 is for example a big commercial building where a lot of employees work. This might cause traffic jams on the road represented by the mobility object MO2. If, for example, the road represented by the mobility object MO1 is a motor-way connecting the area shown in FIG. 8 to other areas of the city whereas the street represented by the mobility object MO3 is a local street, almost all employees will drive from the building represented by the building object BO3 via the connecting lane MO6 and the road represented by the mobility object MO2 directly to the motor-way represented by the mobility object MO1. On their way to the motor-way MO1, the employees will pass the building object BO1 but not the building object BO2. If the employees working in the building represented by the building object BO3 work, for example, from 9 am to 5 pm this may cause a traffic jam on the road lanes of MO2 leading from the building object BO3 to the motor-way MO1 at around 5 pm and to a traffic jam on the road lanes of MO2 leading from the motor-way MO1 in the direction to the building represented by the building object BO3 at around 9 am. This has effects on other city objects of the city as well. For example, by the high traffic, people living in the building represented by the building object BO1 are not only affected by the traffic but also by the pollution and noise caused by the cars standing in the traffic jam. This might degrade their quality of life. In contrast, people living in the other building represented by the building object BO2 would be less affected when a building represented by the building object BO3 is built. When planning the area as shown in FIG. 8, a city planner might substitute the building object BO1 (e.g., a residential building) by another kind of building (e.g., a gas station) or shift the residential building to form the building object BO2 because people living there would be less affected by pollution and noise.

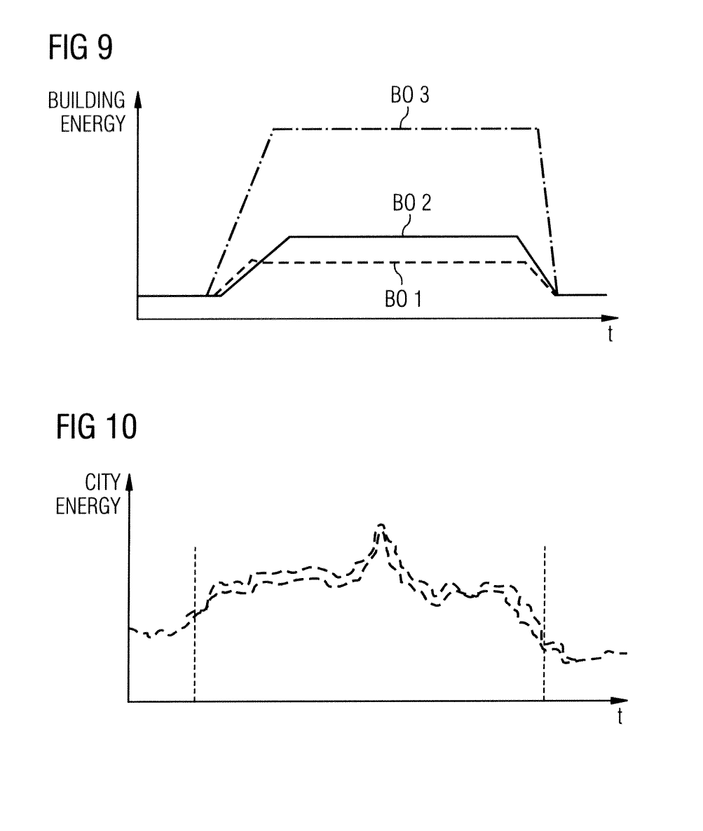

The construction of the building represented by the building object BO3 does also have impacts on other disciplines of the city as well, for example the energy supply. For example, as shown in FIG. 9 energy consumption of the area as shown in FIG. 8 will significantly increase when building the building object BO3 so that the capacity of the energy supply object ESO1 might not be sufficient. The increase of energy consumption has a strong impact to the local area as illustrated in FIG. 9 but might have a comparatively low impact of the whole urban area as shown in FIG. 10. The energy consumption after the office building corresponding to a building object BO3 might be reduced because the photovoltaic unit ESO8 will generate energy in the local area. However, this will depend on the weather on a day-to-day basis. Accordingly, a city stakeholder might simulate different weather scenarios and evaluate the impact of the local and global energy supply situation in the city. The city stakeholder can get a list of key performance indicators (KPI), for example indicating CO₂ emissions or financial key factors. These key performance indicators (KPI) can be calculated for different scenarios, for example with or without a building represented by building object BO3. These key performance indicators (KPI) can also be calculated on the basis of different external factors including for example weather prognosis data or current weather data. The city lifecycle management system 1 does not only calculate key performance indicators (KPI) within the same discipline but also for other disciplines in particular key performance indicators (KPI) showing a social or environmental impact. A decision taken by a city stakeholder on the basis of key performance indicators (KPI) of different disciplines can trigger other decisions on other objects. For example, building a building represented by a building object BO3 can diminish the quality of life as a key performance indicator (KPI) for the people living in the building represented by a building object BO1 and make it necessary to protect the people by constructing, for example, a wall between the road MO2 and the building represented by a building object BO1 to protect the people living in the building BO1 from the pollution and noise caused by the traffic jam on the road represented by the mobility object MO2 during the rush hours around 9 am and 5 pm.

The decision makers or city stakeholders will see the impact of their decision on the different key performance indicators (KPI) to provide a sustainable development of the urban area. For example, a decision with respect to an urban infrastructure object can have a positive impact on some key performance indicators (KPI) and influences other key performance indicators (KPI) negatively. For example, by building a big commercial building represented by a building object BO3 the economic growth in the respective area will be enhanced. However, the quality of life of residents living in the respective area might diminish. Consequently, trade-off effects become visible to city stakeholders in this way. City stakeholders planning a building in the city area, such as a building represented by a building object BO3, might consider disciplines such as the traffic situation or energy supply but might otherwise overlook other effects concerning other disciplines, such as water supply or effects on the environment. The city lifecycle management system 1 helps a city stakeholder or a team of city stakeholders to take a complete look to the effects caused by the decision in different disciplines of the city. In this way, it is also easier for city stakeholders to communicate decisions to residents living in the affected area. In a possible embodiment, residents as well as city stakeholders can have access to the key performance indicators (KPI) calculated by the city lifecycle management system 1, for example via a data network. In this way, citizens of a city can better understand, for example, infrastructure decisions taken by city stakeholders or planners, so that the decision-making process as a whole becomes more transparent. The city lifecycle management system 1 can be used for planning and optimizing infrastructure decisions taking into account the impact on other disciplines, such as environment. Further, a forecast of future developments is possible. The city lifecycle management system 1 can also be used for real-time evaluations of existing urban areas. The city lifecycle management system 1 allows a what-if scenario management and can demonstrate strategic planning. It provides an efficient decision support, facilitates communication, and increases transparency. The city lifecycle management system 1 ensures a seamless data management along the lifecycle of a city or of a city area. The city lifecycle management system 1 can be used for any kind of urban area, such as a big city but also for smaller entities such as towns, communities and even villages. The city lifecycle management system 1 can be linked in a possible embodiment to a virtual reality environment showing city objects in three-dimensional simulations.

In an exemplary use case, the city lifecycle management system 1 can show an interplay or interactions of buildings and traffic. For example, a city stakeholder can model an office park near an existing infrastructure. The existing infrastructure can include residential homes, commercial homes, shopping malls as well as roads. After downloading infrastructure files from a server, the city stakeholder can see that the traffic is balanced through the week days by looking, for example, at road colours coding traffic on roads on a displayed map. For example, a slider allows the city stakeholder to select different times of the day and different days of a week to see whether this has an impact on the traffic flow. City stakeholder can see the impact of constructing a new office park by modelling the three-dimensional office buildings and connecting a building parking lot to existing roads of the infrastructure. The traffic simulation result can show that there is a traffic jam during the morning and evening on week days when employees commute on the road. The city stakeholder can then extend the lanes of an existing road and even construct a complete new road to resolve the traffic issue.

In a further use case, the city lifecycle management system 1 may be used to show the interplay or interactions between buildings and an energy grid of the city. When planning a new office park or big commercial building, this can be built as a prosumer in the city energy grid (e.g., if the building includes a photovoltaic facility as well as energy storages within a certain generation or storage capacity built on the roof of the constructed office park building). The city stakeholder can see the impact of these installations on the energy profile of the respective building by looking at a displayed building energy graph. This aggregated energy graph can show, for example, an electricity demand and a required electric production capacity of the utility. For example, a city stakeholder can see that adding photovoltaic and/or energy storage units will change the daytime energy demand of the building and will have an impact on the energy supply of the city.

As a further use case, the interplay of buildings, traffic and energy can be implemented. For example, a city stakeholder can choose to have a certain percentage of cars as e-cars with the additional assumption that these e-cars will be charged during daytime at the office and at home in the evening. A city stakeholder of the city lifecycle management system 1 can, for example, see that traffic jams are not only causing arrival time delays but will have an impact on the building energy consumption profile. In a possible implementation, the city lifecycle management system 1 can show an impact of at least one made decision on other interesting key performance indicators (KPI), for example within a district of a city. This can be done, for example, from a management point of view or for example from the perspective of a city major. The relevant data can be displayed to a city stakeholder such as the city major through numerical key figures or graphs showing for example on air pollution, energy usage, budget status, average congestion or quality of life of the residents in the district. The city lifecycle management system 1 can use a complete data model of the city with a plurality of city objects of different disciplines for performing an analysis of a decision concerning, for example, the infrastructure of the respective city.

In a possible embodiment, a city stakeholder, such as a city mayor, may invite a plurality of other city stakeholder, for instance residents of the affected district within the city, to vote in favour or against a decision on the basis of the calculated key performance indicators (KPI). The voting may be performed by individuals living in the area or by their representatives.

With the city lifecycle management system 1, the city stakeholders have instant access to up-to-date data and are able to collaborate in an efficient way.

An aspect of the city lifecycle management system 1 tion is the efficient collaboration during the entire lifecycle beginning with first requirements and concept drawings throughout development and engineering phases up to operation and service for a city object.

A second aspect of the city lifecycle management system 1 is the support in the evaluation of taken decisions. The development and engineering acts can be backed by technical analysis and simulations to foresee a behaviour caused by the decision. Accordingly, the city lifecycle management system 1 allows one to substantiate decisions in specific verticals or disciplines. The decision taken with the help of the city lifecycle management system 1 can be recorded and can form part of a report or a decision recommendation. In the city lifecycle management system 1, city objects can be created, changed or cancelled depending on the taken decision. Any taken decision, for instance, with respect to infrastructure objects will have an impact on the city budget. A decision on an infrastructure object may also have an impact on the tax revenues of a city. For example, if a production facility is built within the perimeter of the respective city, the city will get taxes paid by the manufacturer whereas if the production facility is built outside the urban area there will be no affluence of revenues to the city. Accordingly, the city lifecycle management system 1 assists a city stakeholder in planning a budget of the city as well. The city lifecycle management system 1 can also discover automatically inconsistencies and errors when planning an object. A simple example would be the planning of a building object BO having geodetic data indicating that another building is already existing at this location.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A city lifecycle management system for providing for city stakeholders to measure a performance of decisions against key performance indicators (KPI) with respect to a sustainable development of an urban area, said city lifecycle management system comprising:
a data and software platform enabling a collaborative generation and consistent management of city data of said urban area;
a modelling and simulation framework using said data and software platform, wherein said modelling and simulation framework comprises software modules that evaluate interactions between city objects of the same and/or different disciplines; and
an application layer comprising application programs being adapted to derive the key performance indicators (KPI) depending on the interactions evaluated by said software modules of said modelling and simulation framework,
wherein said derived key performance indicators (KPI) support said city stakeholders in making decisions with respect to the sustainable development of the respective urban area.

2. The city lifecycle management system according to claim 1, wherein said software modules of said modelling and simulation framework simulate multi-disciplinary interactions between city objects of different disciplines at different levels of detail and over different time horizons.

3. The city lifecycle management system according to claim 1, wherein said data and software platform comprises a data backbone through which stakeholders of the same or different disciplines exchange data in real-time and have instant access to design rationales and decisions.

4. The city lifecycle management system according to claim 3, wherein said software modules of said modelling and simulation framework have access to actual, historic and planned city data of said urban area stored in at least one data storage of said data and software platform via said data backbone.

5. The city lifecycle management system according to claim 1, wherein said modelling and simulation framework comprises configurable model libraries describing a static or dynamic behaviour of city objects or of relations between city objects within said urban area.

6. The city lifecycle management system according to claim 5, wherein said model libraries describe a behaviour of and relations between the city objects of said urban area, wherein said behaviour of city objects comprises:
a physical behaviour,
a socio-economic behaviour,
a structural behaviour, and
a logical behaviour of said city objects.

7. The city lifecycle management system according to claim 1, wherein said city data comprises city objects within said urban area comprising urban tangible and intangible city data, infrastructure, climatic, ecological and human objects within said urban area relevant to planning and sustainable development of a city.

8. The city lifecycle management system according to claim 7, wherein said urban infrastructure objects are objects of different disciplines comprising:
building objects (BO) including different types of buildings including residential, commercial and public buildings,
mobility objects (MO) including transport, roads, railroads, subways, parking lots, bus stations, train stations, airports, water channels, harbours, pedestrian zones, bridges, tunnels and cycle tracks,
energy supply objects (ESO) including energy generators, energy storage means, energy consumers, energy prosumers, energy distribution entities and power supply lines,
drinking water supply objects (WSO) including water supply tanks, reservoirs, water supply pipes, pumps and valves, water consumers,
water sewage objects including spillway basins, sewer pipes, pumps, valves, rainwater collectors, sewage plants
health care objects including hospitals,
education objects including schools, universities and research facilities,
manufacturing objects including factories and productions facilities, industries,
communication objects including data networks, fixed and cellular telephone networks and mail delivery facilities,
security objects including police stations, monitoring cameras, sensor networks, fire stations,
waste objects including garbage collection, waste recovery, recycling facilities,
environment objects including gardens, recreation parks, lakes, woods, riversides, and
financial objects including expenditures, revenues, transfers, plant maintenance and administration.

9. The city lifecycle management system according to claim 1, wherein said modelling and simulation framework comprises algorithms and assets which are adapted to administer calculations to evaluate the interactions between the city objects of said urban area.

10. The city lifecycle management system according to claim 3, wherein said stakeholders exchange data between each other by means of interfaces connected to said data backbone of said data and software platform.

11. The city lifecycle management system according to claim 1, wherein said application programs of said application layer comprise:
city and infrastructure planning applications,
city and infrastructure design applications,
city management applications,
simulation applications,
optimization applications,
rescue and emergency applications,
social impact evaluation applications,
environment impact evaluation applications, and
forecast applications including short term, mid-term and long term forecast applications.

12. The city lifecycle management system according to claim 1, wherein said key performance indicators (KPI) comprise key performance indicators of cities for different disciplines including emissions, budget, congestion, energy/water/waste/waste-water prosumption, quality of life, economic growth, land use, water usage, refurbishment potential and population development including demographic and employment development.

13. The city lifecycle management system according to claim 1, wherein said city data comprise geodetic data and semantic information of said city objects within said urban area.

14. A method for providing key performance indicators (KPI) forming a basis for decisions taken by stakeholders with respect to a sustainable development of an urban area comprising the acts of:
providing data comprising urban infrastructure objects and/or human objects within said urban area;
evaluating interactions between said objects; and
deriving the key performance indicators (KPI) depending on the evaluated interactions.

15. The method according to claim 14, wherein the interactions between objects of different disciplines are evaluated and simulated at different levels of detail and over different time horizons.

16. The method according to claim 15, wherein the simulation of the interactions between the city objects is performed on the basis of a static or dynamic behaviour of the objects read from module libraries describing a behaviour of city objects and relations between the city objects.
